(19) United States
(12) Patent Application Publication
(10) Pub. No.: US 2015/0275021 A1
(43) Pub. Date: Oct. 1, 2015

(54) FLUID-RESISTANT ELECTRONIC DEVICES

(71) Applicant: Peach State Labs, Inc., Rome, GA (US)

(72) Inventors: Samer SABA, Acworth, GA (US); Hector CHARYTON, Fayetteville, GA (US)

(21) Appl. No.: 14/674,950

(22) Filed: Mar. 31, 2015

Related U.S. Application Data
(60) Provisional application No. 61/972,903, filed on Mar. 31, 2014.

(51) Int. Cl. C09D 127/12; B05D 1/18

(52) U.S. Cl. CPC C09D 127/12; B05D 1/18

(57) ABSTRACT

In one aspect, coated electronic devices are described herein. A coated electronic device comprises interior and exterior surfaces having a coating adhered thereto, the coating comprising a sufficient amount of fluoropolymer to maintain electronic functionality of the device subsequent to immersion of the device in water or oil for an immersion time period exceeding 1 hour. In some embodiments, immersion time of the electronic device in water or oil exceeds 3 hours, 12 hours or 24 hours, wherein electronic functionality of the device is maintained by the fluoropolymer coating.

### RELATED APPLICATION DATA

The present application claims priority under 35 U.S.C. §119(e) to U.S. Provisional Patent Application Ser. No. 61/972,903 filed Mar. 31, 2014, which is incorporated herein by reference in its entirety.

### FIELD

The present invention relates to fluid-resistant electronic devices and, in particular, to hydrophobic and oleophobic electronic devices having fluoropolymer coatings.

### BACKGROUND

Many electronic devices are damaged or destroyed by accidental immersion in liquids or other exposure to liquids. In particular, immersing or otherwise exposing an electronic device to a liquid such as water or oil can result in electrical shorting of one or more components of the device. Therefore, a need exists for improved electronic devices and coatings for electronic devices that increase water and oil resistance of the devices, including after prolonged exposure to and/or complete immersion in water or oil.

### SUMMARY

In one aspect, coated electronic devices and components are described herein which, in some embodiments, overcome or mitigate one or more disadvantages of prior electronic devices regarding resistance to water and oil exposure. For example, a surface of a coated electronic device described herein can have a high contact angle with water and oil, thereby simultaneously imparting desirable water resistance and oil resistance to the electronic device. Moreover, the hydrophobic/oleophobic coating of an electronic device described herein can have high optical transparency, including in the visible region of the electromagnetic spectrum. Further, in some instances, the coating can be adhered to a surface of an electronic device with high strength, thereby demonstrating abrasion resistance and general durability. Surprisingly, a coated electronic device described herein, in some embodiments, continues to function after complete immersion of the device in oil or water, the immersion time exceeding 1 hour, exceeding 3 hours, exceeding 12 hours or exceeding 24 hours.

Interior and exterior surfaces of the electronic device are provided with a fluoropolymer coating to achieve desired hydrophobicity and oloephobicity, permitting continued operation of the electronic device subsequent to prolonged immersion in water and oils. The fluoropolymer can be formed of a monomer including a linear or branched perfluoroalkyl group and a polymerizable moiety such as an acrylate moiety, methacrylate moiety, isocyanate moiety, isothiocyanate moiety or alcohol moiety. For example, in some embodiments, the perfluoroalkyl group is a C₄ to C₂₀ perfluoroalkyl group or a mixture of differing C₄ to C₂₀ perfluoroalkyl groups. Further, in some embodiments, the fluoropolymer is a homopolymer. Alternatively, the fluoropolymer is a copolymer formed from fluorinated monomer with one or more additional monomers, such as monomers comprising an ethyleneically unsaturated moiety, an isocyanate moiety, an isothiocyanate moiety, an alcohol moiety, or a combination thereof.

A coating of an electronic device described herein can be derived from a coating mixture comprising a fluorinated carbon solvent and a fluoropolymer solubilized or dispersed in the fluorinated carbon solvent.

In another aspect, methods of increasing the water resistance and oil resistance of an electronic device are described herein. A method of increasing water and oil resistance of an electronic device comprises applying a coating mixture to interior and exterior surfaces of the electronic device, the coating mixture comprising a fluorinated carbon solvent and a fluoropolymer, wherein a sufficient amount of the fluoropolymer is deposited on the interior and exterior surfaces of the electronic device to maintain electronic functionality of the device subsequent to immersion of the device in water or oil, the immersion time exceeding 1 hour. The coated electronic device, in some embodiments, maintains electronic functionality subsequent to an immersion time in water or oil exceeding 3 hours, 12 hours or 24 hours.

Methods described herein can be administered under ambient conditions, thereby obviating requirements of special coating equipment such as plasma chambers and/or other containment equipment employed in prior fluoropolymer coating techniques. Additionally, in some embodiments, methods described herein further comprise removing at least a fraction or portion of the fluorinated carbon solvent from the coating and recovering the removed fraction of the solvent.

These and other embodiments are described in greater detail in the detailed description which follows.

### DETAILED DESCRIPTION

Embodiments described herein can be understood more readily by reference to the following detailed description and examples. Elements, apparatus, and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

### I. Coated Electronic Devices

In one aspect, coated electronic devices are described herein. A coated electronic device comprises interior and exterior surfaces having a coating adhered thereto, the coating comprising a sufficient amount of fluoropolymer to maintain electronic functionality of the device subsequent to immersion of the device in water or oil for an immersion time period exceeding 1 hour. In some embodiments, immersion time of the electronic device in water or oil exceeds 3 hours, 12 hours or 24 hours, wherein electronic functionality of the device is maintained by the fluoropolymer coating. Electronic functionality, as used herein, refers to one or more electronic functions of the device. For example, electronic functionality of a mobile or cellular phone is the ability to place and receive calls. Another electronic functionality of a mobile or cellular phone is the ability to transmit and receive data. Accordingly, either or both of these electronic functionalities are maintained operational by the applied fluoropolymer coating subsequent to immersion of the mobile or cellular phone in water or oil for an immersion time period exceeding 1 hour. Moreover, electronic functionality will vary with the specific type and/or identity of the electronic device.

Any fluoropolymer not inconsistent with the objectives of the present invention can be used in coatings for interior and exterior surfaces of electronic devices. In some embodiments, a fluoropolymer is formed of monomer comprising a linear or branched perfluoroalkyl group and a polymerizable moiety. For example, in some cases, fluoropolymer of a coating described herein is a perfluoroacrylate, perfluoromethacrylate, perfluorourethane, perfluoropolyolefin, perfluoropolyvinyl or mixtures thereof. Suitable fluoropolymer can include perfluoroalkyl pendant groups and a polyacrylate, polymethacrylate, polyurethane or polyolefin backbone or main chain.

In some embodiments, fluoropolymer of a coating described herein is formed of monomer of Formula (I):

R_{f}—(CH₂)ₙ—P (I),

wherein R_{f} is a linear or branched perfluoroalkyl group, P is a polymerizable moiety and n is an integer from 1 to 10, 1 to 5, or 1 to 3. In some embodiments, R_{f} is a C₄ to C₂₀ perfluoroalkyl group, such as a C₆ perfluoroalkyl group, a C₈ perfluoroalkyl group, a C₁₀ perfluoroalkyl group, a C₁₂ perfluoroalkyl group or a C₁₄ perfluoroalkyl group. Moreover, in some cases, R_{f} is a mixture of C₄ to C₂₀ perfluoroalkyl groups. Such a mixture of C₄ to C₂₀ perfluoroalkyl groups can be obtained from telomerization processes. In some cases, R_{f} is a mixture of C₈ to C₁₅ perfluoroalkyl groups. In some embodiments, R_{f} is a mixture of C₈ and C₁₀ perfluoroalkyl groups or a mixture of C₆, C₈, C₁₀, C₁₂, and C₁₄ perfluoroalkyl groups, with C₆ being the dominant fraction.

In addition, polymerizable moiety P can be an ethyleneically unsaturated moiety, such a vinyl moiety, an acrylate moiety, or a methacrylate moiety. Alternatively, P is an isocyanate moiety, an isothiocyanate moiety or an alcohol moiety. Moreover, in some cases, P is a polyol moiety. In some embodiments, polymerizable moiety P has the structure of Formula (II):

—OC(O)—X—R₁ (II),

wherein X is a direct bond or —NR₂—, R₁ is a linear or branched alkyl, alkenyl, or aryl group having 1 to 20 carbon atoms, and R₂ is hydrogen, methyl, ethyl, or propyl, provided that if X is a direct bond, then R₁ includes at least one carbon-carbon double-bond.

Fluoropolymer of a coating described herein can be a homopolymer formed from monomer of Formula (I) or from another perfluoroalkyl-containing monomer. In other embodiments, fluoropolymer of a coating described herein is a copolymer formed from perfluoroalkyl-containing monomer, such as the monomer of Formula (I), copolymerized with one or more additional monomeric species. Any additional monomeric species not inconsistent with the objectives of the present invention may be used. In some cases, for example, additional monomeric species employ an ethyleneically unsaturated moiety, an isocyanate moiety, an isothiocyanate moiety, an alcohol moiety or a combination of one or more of the foregoing. Monomer having an ethyleneically unsaturated moiety can comprise an olefin compound, a vinyl compound or an acrylate or methacrylate compound. Moreover, monomer comprising an ethyleneically unsaturated moiety, in some cases, comprises a plurality of ethyleneically unsaturated moieties. For example, additional monomeric species can include a divinyl compound, a diacrylate compound, a dimethacrylate compound or a trivinyl compound, a triacrylate compound, or a trimethacrylate compound. Further, in some embodiments, one or more additional monomers can comprise a diisocyanate, a polyol or a combination of one or more diisocyanates and one or more polyols.

Specific non-limiting examples of additional monomeric species suitable for use in some embodiments described herein include acrylic acid, acrylic anhydride, alkyl acrylates having 1 to 20 carbon atoms, hydroxyalkyl acrylates having 1 to 20 carbon atoms, methacrylic acid, methacrylic anhydride, alkyl methacrylates having 1 to 20 carbon atoms, hydroxyalkyl methacrylates having 1 to 20 carbon atoms, maleic anhydride, acryloyl chloride, methacryloyl chloride, and methyl-, ethyl-, propyl-, butyl-, or hydroxyl-capped polyethylene glycols. Other monomers may also be used.

Fluoropolymer of coatings described herein, in some embodiments, are consistent with those described in U.S. Pat. No. 7,435,774 which is hereby incorporated by reference in its entirety.

As described herein, the fluoropolymer coating is adhered to interior and exterior surfaces of the electronic device. Any electronic device not inconsistent with the objectives of the present invention may be used. In some embodiments, an electronic device is a communication device such as a phone, mobile phone, radio, tablet, computer, television, camera, airborne drone apparatus or global positioning system (GPS). In other cases, an electronic device is a component or portion of an electronic apparatus or system. For example, in some embodiments, an electronic device can be a printed wiring board (PWB), printed circuit board (PCB) or a battery.

Additionally, as described further herein, the presence of fluoropolymer coating on one or more surfaces of an electronic device, in some embodiments, does not substantially affect or degrade the normal operation of the electronic device. For example, in some embodiments, the electrical conductivity of a surface of an electronic device is unaffected or substantially unaffected by the coating. Thus, the surface of a male and/or female electrical connector such as a jack, plug, blade connector, ring and spade terminal, socket, USB port, or other electrical connector can function properly even when coated with a fluoropolymer described herein.

More generally, the fluoropolymer coating can itself have a variety of properties and/or impart a variety of properties to a coated electronic device. For example, in some cases, the coating can have a high contact angle with water and oil, thereby imparting water resistance and oil resistance to the underlying surface of the electronic device. As described herein, a sufficient amount of fluoropolymer is deposited in the coating to maintain electronic functionality of the electronic device subsequent to immersing the device in water or oil for an immersion time period exceeding 1 hour. The immersion time period, in some embodiments, is selected from Table I.

TABLE I
Immersion Time of Electronic Device in Oil or Water
Time (hours)

>3
>6
>12
>24
3-24
1-6
1-3

Moreover, in some instances, a coated electronic device described herein can continue to function while completely immersed in water and also, separately, while completely immersed in oil. Thus, in some embodiments, a coated electronic device described herein is both highly water resistant and highly oil resistant. “Oil,” for reference purposes herein, can comprise organic (hydrocarbon) oil or inorganic oil. In some embodiments, oil comprises silicone oil. In other instances, oil comprises motor oil, including used or dirty motor oil. Similarly, “water” can include pure water or an aqueous solution or mixture. Further, in some embodiments, an aqueous mixture comprises a soap, detergent, surfactant, or other amphiphilic species dispersed in water.

In addition to being hydrophobic and oleophobic, a coating described herein can also be abrasion resistant, demonstrating general durability. Further, a coating described herein can also have high optical transparency, including in the visible region of the electromagnetic spectrum. In some embodiments, for example, a coating of a coated electronic device has an optical transparency of at least about 80 percent, at least about 90 percent, or at least about 95 percent between about 350 nm and about 750 nm. In some cases, a coating exhibits a transparency of at least about 98 percent or at least about 99 percent between about 350 nm and about 750 nm.

Moreover, a coating described herein can exhibit or provide one or more properties described above when the coating is present at a variety of thicknesses. A coating described herein can have any average thickness not inconsistent with the objectives of the present invention. In some cases, a coating has an average thickness of up to about 10 μm, up to about 5 μm or up to about 1 μm. In some embodiments, a coating has an average thickness of up to about 500 nm, up to about 100 nm or up to about 50 nm. In some embodiments, a coating has an average thickness selected from Table II.

```
TABLE II
Fluoropolymer Coating Thickness
50 nm-5 μm
50 nm-1 μm
  50 nm-500 nm
250 nm-2 μm
500 nm-5 μm
  1 μm-10 μm
```

Other thicknesses are also possible depending on type of electronic device, compositional parameters of the coating mixture and intended application.

Further, the fluoropolymer coating, in some embodiments, is in the as-deposited state. In being in the as-deposited state, the fluoropolymer coating is not subjected to any post-processing techniques. Alternatively, the fluoropolymer coating can be in an annealed state. For example, the fluoropolymer coating can be subjected to heat treatment subsequent to deposition. Heat treatment can vary depending on the identity of the fluoropolymer and electronic device. In some embodiments, the fluoropolymer coating is annealed at a temperature of 20-100° C. for a time period of 5-60 minutes. Annealed fluoropolymer coating can exhibit a different microstructure compared to fluoropolymer coating in the as-deposited state.

As described further hereinbelow, a coating of an electronic device can be formed in a variety of manners. In some cases, a coating described herein is derived or formed from a coating mixture comprising a fluorinated carbon solvent and a fluoropolymer solubilized or dispersed in the fluorinated carbon solvent. Such a coating mixture, in some cases, comprises a solution of the fluoropolymer in the fluorinated carbon solvent. In other instances, such a coating mixture comprises an emulsion of the fluoropolymer in the fluorinated carbon solvent. The fluoropolymer of the coating mixture can comprise any fluoropolymer described hereinabove. For example, in some cases, the fluoropolymer comprises a homopolymer or copolymer formed from monomer of Formula (I) above. Similarly, the fluorinated carbon solvent of a coating mixture can comprise any fluorinated carbon solvent not inconsistent with the objectives of the present invention. Generally, suitable fluorinated carbon solvents are non-reactive to electronic devices and components and volatilize under ambient conditions. Evaporation under ambient conditions facilities application of fluoropolymer coatings to electronic devices and permits recapture of the solvent for recycling. In some embodiments, a fluorinated carbon solvent comprises a perfluorocarbon, such as a perfluoroalkane. A non-limiting example of a fluorinated carbon solvent suitable for use in some embodiments described herein is 2,3-dihydrodecafluoropentane. Other fluorinated carbon solvents may also be used.

Fluoropolymer can be present in the fluorocarbon solvent in any amount not inconsistent with the objectives of the present invention. A coating mixture, for example, can comprise about 1 to about 5 weight percent solids fluoropolymer. Additional amounts of fluoropolymer in the coating mixture are provided in Table III.

TABLE III
Coating Mixture Fluoropolymer Content
Fluoropolymer-wt. % Solids
0.5-3
1-4
2.5-3.5
0.1-1
2-4

### II. Methods of Increasing the Water and Oil Resistance of an Electronic Component

In another aspect, methods of increasing the water resistance and oil resistance of an electronic device are described herein. A method of increasing water and oil resistance of an electronic device comprises applying a coating mixture to interior and exterior surfaces of the electronic device, the coating mixture comprising a fluorinated carbon solvent and a fluoropolymer, wherein a sufficient amount of the fluoropolymer is deposited on the interior and exterior surfaces of the electronic device to maintain electronic functionality of the device subsequent to immersion of the device in water or oil, the immersion time exceeding 1 hour. The coated electronic device, in some embodiments, maintains electronic functionality subsequent to an immersion time in water or oil exceeding 3 hours, 12 hours or 24 hours. In some instances, the coating is applied to all or substantially all of the interior and exterior surfaces of the electronic component, except, if desired, one or more optical surfaces.

Additionally, a coated electronic device can function while completely immersed in water or oil. In some embodiments, the coated electronic device functions while completely immersed in water or oil for a time period set forth in Table I herein.

Any coating mixture not inconsistent with the objectives of the present invention may be used, including any coating mixture described hereinabove in Section I. For example, in some cases, the coating mixture comprises a solution of the fluoropolymer in the fluorinated carbon solvent. In other cases, the coating mixture comprises an emulsion of the fluoropolymer in the fluorinated carbon solvent. The fluorinated carbon solvent can comprise a fluorinated alkane such as 2,3-dihydrodecafluoropentane. Similarly, the fluoropolymer of a coating mixture can comprise any fluoropolymer described hereinabove in Section I. For example, fluoropolymer of a coating mixture, in some embodiments, comprises a homopolymer or copolymer formed from monomer of Formula (I) above. In addition, the fluoropolymer can be present in the mixture in an amount selected from Table III herein.

The coating mixture can be applied to a surface of an electronic device in any manner not inconsistent with the objectives of the present invention. In some embodiments, for instance, the coating mixture is brushed, rolled, sprayed, dropped, spun, or cast onto the surface, including by spin coating, spin casting, or drop casting. In other cases, the coating is disposed on one or more surfaces of the electronic device by dipping or immersing all or a portion of the electronic device in the coating mixture.

A method of coating an electronic device can further comprise removing at least a fraction or portion of the solvent from the coating, such as by drying or evaporating the solvent, and recovering the removed fraction of the solvent. For example, evaporated solvent can be recondensed and thereby recovered for further use or re-use, including in a method described herein. As understood by one of ordinary skill in the art, such evaporation and recondensation of a solvent can be carried out using a variety of apparatus. In this manner, a substantial portion of fluorinated carbon solvent can be repeatedly used and re-used, thereby decreasing the cost and/or environmental impact of a method described herein. In some embodiments, for instance, at least about 70 percent, at least about 80 percent, or at least about 90 percent of a solvent is removed from a coating described herein and recovered.

Further, the deposited fluoropolymer coating, in some embodiments, is subjected to an annealing step as described in Section I above.

Some embodiments described herein are further illustrated in the following non-limiting examples.

### Example 1

### Coated Electronic Device

A mobile phone (LG Model NTLG300GB) was disassembled and components of the phone were dipped in a coating mixture. In particular, the following components were dipped in the coating mixture: the battery, the SIM card, the outside casing, and the motherboard. However, the coating mixture was not applied to the plastic and glass screen. The display screen of the phone was not dipped in the coating mixture. The coating mixture consisted of a solution of a fluoropolymer formed from a monomer of Formula (I) above. Specifically, the fluoropolymer was dispersed in 2,3-dihydrodecafluoropentane in an amount of 3 weight percent, based on the total weight of the coating mixture. Following dip coating, the dipped components were permitted to air dry at room temperature (25° C.). The dried components, and the display screen, were reassembled, and the phone was observed to operate normally.

Next, the phone was completely immersed in the washing tub of a top-loading washing machine. The washing tub was filled with water having a temperature of approximately 90° F. and including the manufacturer's recommended amount of laundry detergent. The phone was left in the washing machine for the entire washing cycle, which included agitation and spin cycles and lasted approximately 40 minutes. The phone was then removed from the washing machine. The phone was observed to operate normally following this process. Normal operation continued for more than 12 hours until the batter was completely drained.

### Example 2

### Coated Electronic Device

A mobile phone (LG Model NTLG300GB) was disassembled and components of the phone were dipped in a coating mixture. In particular, the following components were dipped in the coating mixture: the battery, the SIM card, the outside casing, and the motherboard. However, the coating mixture was not applied on the plastic and glass screen. The coating mixture consisted of a solution of a fluoropolymer formed from a monomer of Formula (I) above. Specifically, the fluoropolymer was dispersed in 2,3-dihydrodecafluoropentane in an amount of 3 weight percent, based on the total weight of the coating mixture. Following dip coating, the dipped components were permitted to air dry at room temperature (25° C.). The dried components, and the display screen, were reassembled, and the phone was observed to operate normally.

Next, the phone was placed on a table top with the phone's display screen facing up. The contents of a 12-ounce can of a freshly opened SPRITE soft drink were then rapidly poured over the top of the phone. The phone was observed to operate normally during and after exposure to the soft drink. Normal operation continued for more than 24 hours until the battery was completely drained.

### Example 3

### Coated Electronic Device

A mobile audio player device (Philips SBA3010/37 SoundShooter Portable Speaker) was completely immersed in a coating mixture. The coating mixture consisted of a solution of a fluoropolymer formed from a monomer of Formula (I) above. Specifically, the fluoropolymer was dispersed in 2,3-dihydrodecafluoropentane in an amount of 3 weight percent, based on the total weight of the coating mixture. Following dip coating, the device was permitted to air dry at room temperature (25° C.). The dried device was attached to a power supply using a power cord. The device was observed to operate normally.

Next, the device was completely immersed in a container of tap water at a temperature of about 25° C. The power cord was attached to the device and was partially immersed and partially above the water. The device remained immersed for approximately 360 minutes and then removed. The device was observed to operate normally and continuously during and following immersion in the water, as evidenced, for example, by the continual and uninterrupted playing of an audio recording during and following immersion. Normal operation continued for more than 48 hours until the battery was completely drained.

### Example 4

### Coated Electronic Device

A mobile phone (Apple iPhone 4S) was disassembled and components of the phone were dipped in a coating mixture. In particular, the following components were dipped in the coating mixture: the battery, the SIM card, the outside casing, and the motherboard. The display screen of the phone was not dipped in the coating mixture. The coating mixture consisted of a solution of a fluoropolymer formed from a monomer of Formula (I) above. Specifically, the fluoropolymer was dispersed in 2,3-dihydrodecafluoropentane in an amount of 3 weight percent, based on the total weight of the coating mixture. Following dip coating, the dipped components were permitted to air dry at room temperature (25° C.). The dried components, and the display screen, were reassembled, and the phone was observed to operate normally.

Next, the phone was completely immersed in a container of water at approximately 25° C. The phone was left in the container for approximately 5 minutes and then removed. The phone was observed to operate normally during and after immersion, as evidenced, for example, by the continual operation and display of a stopwatch feature of the phone. Normal operation continued for more than 12 hours until the battery was completely drained.

### Example 5

### Coated Electronic Device

A mobile phone (Blackberry Bold 9000) was disassembled and components of the phone were dipped in a coating mixture. In particular, the following components were dipped in the coating mixture: the battery, the SIM card, the outside casing, and the motherboard. The coating mixture was not applied to the plastic and glass display screen of the phone. The coating mixture consisted of a solution of a fluoropolymer formed from a monomer of Formula (I) above. Specifically, the fluoropolymer was dispersed in 2,3-dihydrodecafluoropentane in an amount of 3 weight percent, based on the total weight of the coating mixture. Following dip coating, the dipped components were permitted to air dry at room temperature (25° C.). The dried components, and the display screen, were reassembled, and the phone was observed to operate normally.

Next, the phone was completely immersed in a container of used motor oil at approximately 25° C. The phone was left in the container for approximately 6 minutes and then removed. The phone was observed to operate normally after immersion, as evidenced, for example, by the continual operation and display of a stopwatch feature of the phone. Normal operation continued for more than 24 hours until the battery was completely drained.

### Example 6

### Coated Electronic Device

A tablet device (Proscan Model No. PLT7033D) was disassembled and components of the phone were dipped in a coating mixture. In particular, the following components were dipped in the coating mixture: the battery, the outside casing, and the motherboard. The display screen of the device was not dipped in the coating mixture. The coating mixture consisted of a solution of a fluoropolymer formed from a monomer of Formula (I) above. Specifically, the fluoropolymer was dispersed in 2,3-dihydrodecafluoropentane in an amount of 3 weight percent, based on the total weight of the coating mixture. Following dip coating, the dipped components were permitted to air dry at room temperature (25° C.). The dried components, and the display screen, were reassembled, and the device was observed to operate normally. Specifically, the device was attached to an external speaker using a cord, jack and socket connection. An audiovisual recording was then played by the external speaker and displayed on the tablet's display screen.

Next, the tablet device was placed in a glass container. The speaker cord remained attached to the device, and the external speaker was placed outside of the glass container. The container was then gradually filled with water, eventually covering the device entirely. The device was left in the container for approximately 5 minutes and then removed. The device was observed to operate normally during and after immersion, as evidenced, for example, by the continual and uninterrupted display of the audiovisual recording on the display screen of the device and the continual and uninterrupted playing of the audiovisual recording by the external speaker connected to the device. Normal operation continued for more than 2 hours until the battery was drained.

Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. An electronic device comprising:
interior and exterior surfaces having a coating adhered thereto, the coating comprising a sufficient amount of fluoropolymer to maintain electronic functionality of the device subsequent to immersion of the device in water or oil for an immersion time period exceeding one hour.

2. The electronic device of claim 1, wherein the immersion time period exceeds 3 hours.

3. The electronic device of claim 1, wherein the immersion time period exceeds 12 hours.

4. The electronic device of claim 1, wherein the electronic device is a communication device.

5. The electronic device of claim 4, wherein the communication device is selected from the group consisting of a mobile phone, radio, tablet, computer, television, camera, airborne drone or global positioning system (GPS).

6. The electronic device of claim 1, wherein the fluoropolymer comprises a polymer formed from monomer of Formula (I):
R_{f}—(CH₂)ₙ—P (I),
wherein R_{f} is a linear or branched perfluoroalkyl group, P is a polymerizable moiety, and n is an integer from 1 to 3.

7. The electronic device of claim 6, wherein R_{f} is a mixture of C₄ to C₂₀ perfluoroalkyl groups.

8. The electronic device of claim 7, wherein R_{f} is a C₆ perfluoroalkyl group.

9. The electronic device of claim 6, wherein P is an ethyleneically unsaturated moiety.

10. The electronic device of claim 9, wherein P is an acrylate or methacrylate moiety.

11. The electronic device of claim 1, wherein the coating has a thickness of about 50 nm to about 5 μm.

12. The electronic device of claim 1, wherein the coating has an optical transparency of at least about 80 percent between about 350 nm and about 750 nm.

13. The electronic device of claim 1, wherein the coating is annealed.

14. A method of increasing water and oil resistance of an electronic device comprising:
applying a coating mixture to interior and exterior surfaces of the electronic device, the coating mixture comprising a fluorinated carbon solvent and a fluoropolymer, wherein a sufficient amount of the fluoropolymer is deposited on the interior and exterior surfaces of the electronic device to maintain electronic functionality of the device subsequent to immersion of the device in water or oil, the immersion period time exceeding one hour.

15. The method of claim 14, wherein the fluoropolymer is present in the coating mixture in an amount of 1 to 5 weight percent solids.

16. The method of claim 14, wherein the immersion time period exceeds 30 minutes.

17. The method of claim 14, wherein the electronic device is a communication device.

18. The method of claim 17, wherein the communication device is selected from the group consisting of a mobile phone, radio, tablet, computer, television or global positioning system (GP S).

19. The method of claim 14, wherein the fluoropolymer comprises a polymer formed from monomer of Formula (I):
R₇—(CH₂)ₙ—P (I),
wherein R_{f} is a linear or branched perfluoroalkyl group, P is a polymerizable moiety, and n is an integer from 1 to 3.

20. The method of claim 19, wherein R_{f} is a C₆ perfluoroalkyl group.

21. The method of claim 19, wherein P is an ethyleneically unsaturated moiety.

22. The method of claim 21, wherein P is an acrylate or methacrylate moiety.

23. The method of claim 14 further comprising evaporating the fluorinated carbon solvent and annealing the deposited fluoropolymer.
